(19) United States
(12) Patent Application Publication
(10) Pub. No.: US 2026/0230737 A1
(43) Pub. Date: Aug. 6, 2026

(54) ADAPTABLE HEADSET

(71) Applicant: Lenovo (United States) Inc., Morrisville, NC (US)

(72) Inventors: Jujuan Mitchell, Raleigh, NC (US); Christopher Osborne, Cary, NC (US); Ada Lopez, Raleigh, NC (US); Dana Cockrum Gierdowski, Raleigh, NC (US); Brian Lee, Raleigh, NC (US); Brian Richardson, Columbus, GA (US); Katrina Andrews, Apex, NC (US); Matthew Horn, Cary, NC (US)

(21) Appl. No.: 19/047,378

(22) Filed: Feb. 6, 2025

(51) Int. Cl. H04R 1/10

(52) U.S. Cl. CPC H04R 1/1008; H04R 1/1058

(57) ABSTRACT

An adaptable headset includes a head band adapted to reside on a user head, the head band including a first head band end and a second head band end. A pair of earcups is supported by one of the first head band end or second head band end to reside proximate an ear of the user. Each earcup includes a first earcup portion coupled to the first head band end or the second head band end, a first speaker supported within the first earcup portion, and a second earcup portion detachably couplable to the first earcup portion.

### BACKGROUND

Headsets are widely used in various applications, including gaming, telecommunication, and multimedia consumption. However, users who wear glasses or earrings often face significant challenges when using conventional headsets. These challenges can lead to discomfort, reduced usability, and even physical pain, which can detract from the overall user experience.

One of the primary issues is that traditional headsets are not designed to accommodate the additional space required by glasses. The rigid earcups and head bands can press against the frames of the glasses, causing pressure points on the temples and behind the ears. This pressure can lead to headaches, soreness, and general discomfort, making it difficult for users to wear the headset for extended periods.

Similarly, users who wear earrings, especially larger or more elaborate designs, may find that standard headsets do not provide enough clearance. The earcups can press against the earrings, causing pain and potentially damaging the jewelry. This issue is particularly problematic for users who prefer to keep their earrings on while using the headset, as they must constantly adjust the position of the earcups to avoid discomfort.

Additionally, the lack of adjustability in traditional headsets means that users with different head sizes and shapes may struggle to find a comfortable fit. This lack of customization can lead to a suboptimal audio experience, as the earcups may not form a proper seal around the ears, resulting in sound leakage and reduced audio quality.

Overall, the inability of conventional headsets to accommodate glasses and earrings highlights the need for a more adaptable and user-friendly design. Addressing these issues is crucial for enhancing the comfort and usability of headsets for a broader range of users.

### SUMMARY

An adaptable headset includes a head band adapted to reside on a user head, the head band including a first head band end and a second head band end. A pair of earcups is supported by one of the first head band end or second head band end to reside proximate an ear of the user. Each earcup includes a first earcup portion coupled to the first head band end or the second head band end, a first speaker supported within the first earcup portion, and a second earcup portion detachably couplable to the first earcup portion.

### BRIEF DESCRIPTION OF THE DRAWINGS

FIG. 1 is a perspective view of an adaptable headset according to an example embodiment.

FIG. 2 is a perspective view of an inside (ear facing) of a detachable earcup 200 having an upper portion 210 and lower portion 215 shown as detached according to an example embodiment.

FIG. 3 is a perspective view of and outside (opposite the ear side) of earcup according to an example embodiment.

FIG. 4 is a perspective view of an inside of a detachable earcup having an upper portion and lower portion shown as detached according to an example embodiment.

FIG. 5 is a perspective view of a user 500 wearing a headset 510 with at least one earpiece 515 in a separated or detached state according to an example embodiment.

FIG. 6 shows side view representations of headset 600 having an upper portion earcup separated from a lower portion earcup and in two different states of rotation according to an example embodiment.

FIG. 7 is a front view of a user 700 wearing a headset 710, which may or may not have adjustable earcups according to an example embodiment.

FIG. 8 is a perspective view of a user 800 wearing a headset 810 which may or may not have adjustable earcups according to an example embodiment.

FIG. 9 is a perspective view of the user 800 wearing the headset 810 around the user's neck and resting on their shoulders according to an example embodiment.

FIG. 10 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized, and that structural, logical and electrical changes may be made without departing from the scope of the present invention. The following description of example embodiments is, therefore, not to be taken in a limited sense, and the scope of the present invention is defined by the appended claims.

Headsets for gaming and other applications should be more inclusive and accessible for all users. The inventors have recognized that users want adjustable headsets to fit their changing needs while gaming or participating in other activities. An improved headset includes earcups that adjust to fit earrings and eyeglass frames. The headset adaptably fits over the user's headgear or hairstyle.

The comfort of the headset is very important. The improved headset helps to relieve fatigue when worn around neck. The adaptable headset includes earcup portions that are moveable or detachable to allow the user to remove portions to make the fit more comfortable.

In one example, the improved headset has adjustable earcups that detach or swivel to fit IEM cords (a cable designed to connect to in-ear-monitors), earrings, or headgear. Users will be able to engage in multiple activities, such as listening to gameplay in one ear and sound from another application, such as Discord®, in the other ear. Separate audio activities will be provided to each earcup of the headset to provide separate sound in each ear. A neck speaker option relieves fatigue and exhaustion from wearing a headset for a long time as sound will be perceivable by the user with the headset off the ears and resting around the neck of the user. Forward-facing lighting may be provided via light emitting diodes or other light sources having different colors selected to alert others the user's status, such as on a call, playing a game, or muted.

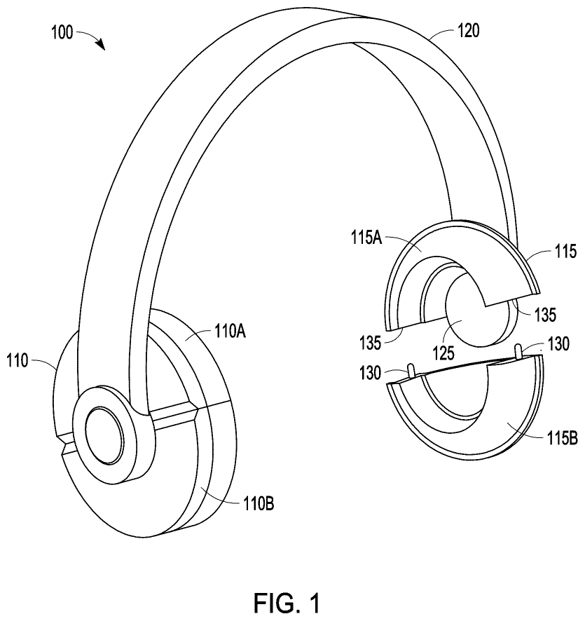

FIG. 1 is a perspective view of an adaptable headset 100. Headset 100 includes a first earcup 110 and a second earcup 115 coupled by a head band 120. First earcup 110 includes a first earcup portion 110A and a second earcup portion 110B. First earcup portion 110A is shown as a top portion with second earcup portion 110B shown as a bottom detachable portion. A speaker is included in first earcup 110 to provide sound from one or more sound inputs that may be included in headset 100, connected via a Bluetooth® or other means of connection such as a cord, not shown.

Second earcup 115 is shown with a first earcup portion 115A and a second earcup portion 115B separated. First earcup portion 115A remains attached or supported by head band 120 and contains a speaker 125 to provide sound from one or more inputs. Second earcup portion 115B is shown separated from first earcup portion 115A and may be stored separately. Second earcup portion 110B may also be detached from first earcup portion 110A and stored.

In one example, one or more projections 130 may extend from second earcup portion 115B to mate with openings 135 in first earcup portion 115A. The projections 130 and openings may form a friction fit such that the earcup portions remain attached for normal use of the headset 100 or may be separated with a suitable amount of force. The projections 130 and openings 135 form a keying mechanism such that the second earcup 115 with both the first and second earcup portions 115A, 115B attached operate as a standard headset. In further examples, magnets may be used to hold the earcup portions in place for normal use in a coupled state, while allowing easy separation for use in a separated state. Both the first earcup 110 and second earcup 115 may be similarly constructed and operate in the same manner.

In various examples, the earcups may have a round shape, an oval shape, a racetrack shape or other suitable shape for wearing over an ear of a user.

By detaching the second earcup portion 110B and second earcup portion 115B, the headset 100 may be adjusted and configured to accommodate earrings, eyeglass frames, and headgear. In one example, the first earcup portion 110A and first earcup portion 115A are rotatably coupled to the head band 120 to enable swiveling to better accommodate material and devices worn or used by the user and provide a more comfortable fit.

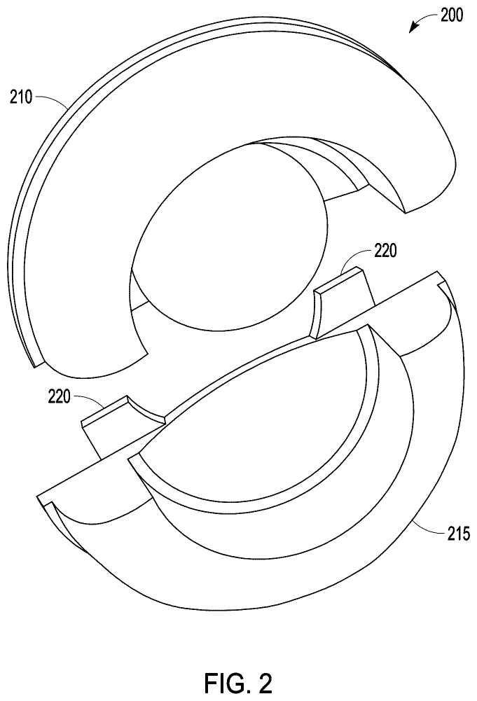

FIG. 2 is a perspective view of an inside (ear facing) of a detachable earcup 200 having an upper portion 210 and lower portion 215 shown as detached. Lower portion 215 is shown with projections 220 that engage mating openings (not visible) in upper portion 210. The projections 220 may be rectangular in general shape and provide for a friction fit with the openings.

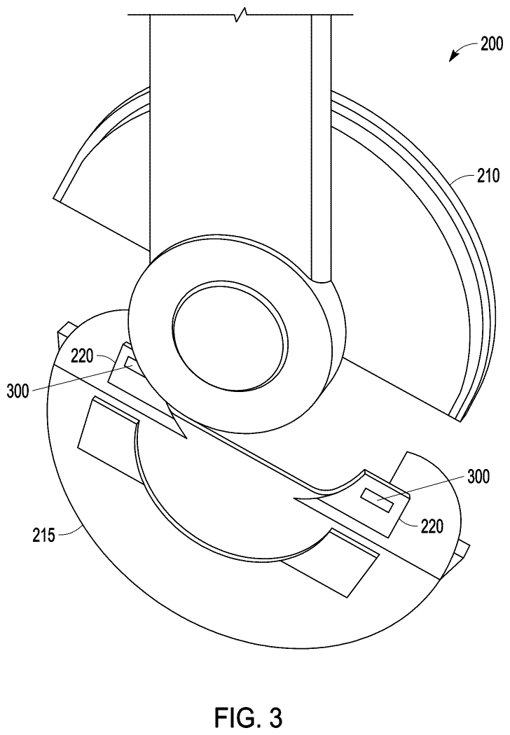

FIG. 3 is a perspective view of and outside (opposite the ear side) of earcup 200. The projections 220 include protrusions 300 to mate with slots inside the openings of upper portion 210. The material for the protrusions may be flexible with the projections and corresponding slots providing a more stable connection of the upper portion 210 and lower portion 215 when placed in the coupled or attached state.

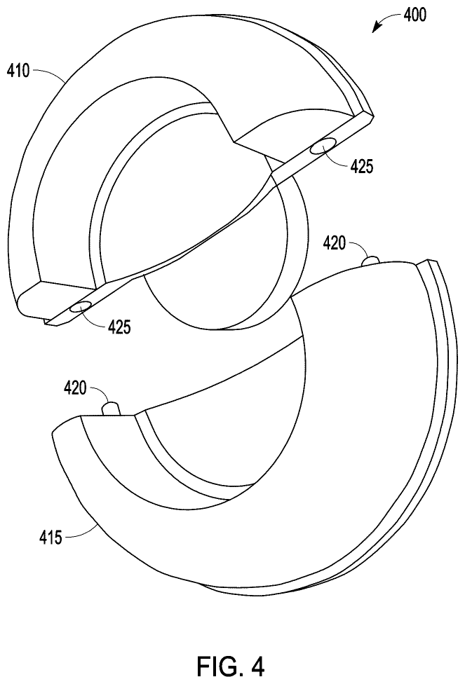

FIG. 4 is a perspective view of an inside (ear facing) of a detachable earcup 400 having an upper portion 410 and lower portion 415 shown as detached. Lower portion 415 is shown with round, peg-like projections 420 that engage mating round openings 425 in upper portion 410. The projections 420 provide for a friction fit with the openings. The projections 420 may be tipped with magnets to mate with magnetic material in the openings 425. In further examples, the openings 425 may contain magnets to mate with magnetic material in the projections 420.

FIG. 5 is a perspective view of a user 500 wearing a headset 510 with at least one earpiece 515 in a separated or detached state. In the detached state, the earpiece 515 does not interact with either earring 520 or a cord 525 such as an IEM cord.

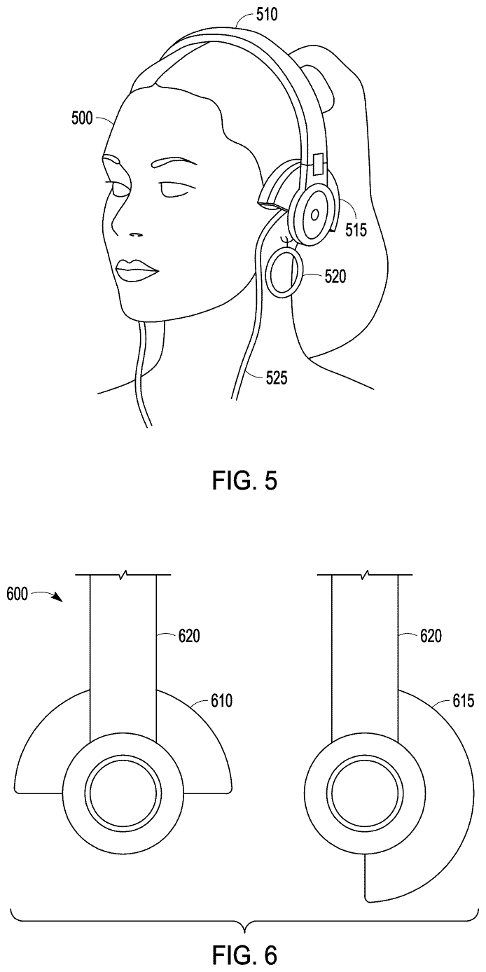

FIG. 6 shows side view representations of headset 600 having an upper portion earcup separated from a lower portion earcup and in two different states of rotation at 610 and 615. The upper portion is rotatable coupled to a head band 620. At 610, the upper portion is in a not rotated state. At 615, the upper portion has been rotated about 90 degrees. The 90 degree rotation at 615 enables the earcup to reside around the back of the user's ear and may be performed by the user to avoid having the earcup contact glasses being worn by the user or for another desired reason.

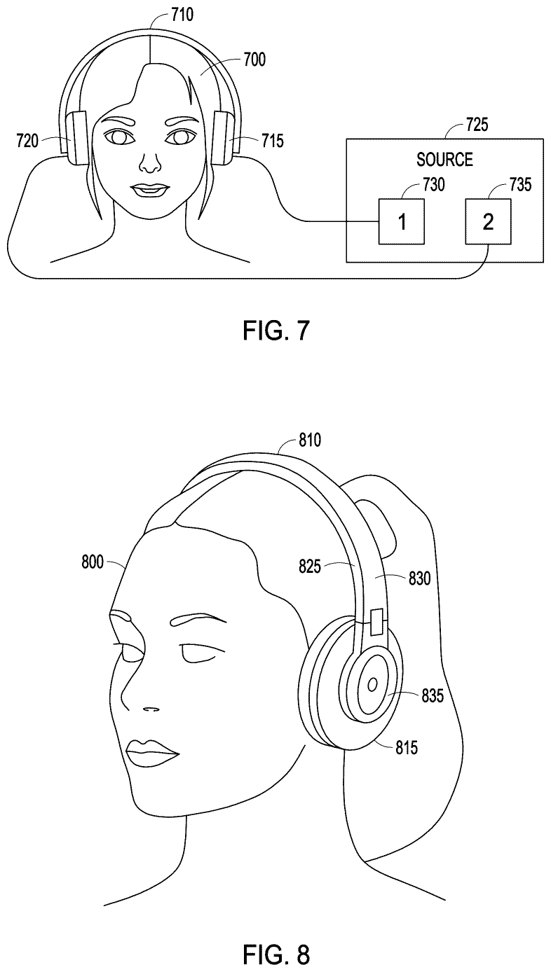

FIG. 7 is a front view of a user 700 wearing a headset 710, which may or may not have adjustable earcups. Headset 700 includes a left earcup 715 and a right earcup 720 from the user's perspective. The earcups may be connected to a game system or other computer or audio source 725 via a wired connection or a wireless connection. Each earcup may receive a different channel 730 and 735 of sound enabling the user to listen to different audio sources in each ear. The channels may provide stereo sound, including left and right channels, or may provide sound from separate sources, such as game play sounds and sound from another user playing the same game in a shared gaming experience, such as a Discord® game. In one example, sound from two different games may be played on the separate channels.

FIG. 8 is a perspective view of a user 800 wearing a headset 810 which may or may not have adjustable earcups. Headset 810 is shown with an earcup 815 coupled to a head band 820. In addition to an earcup speaker in earcup 815, a front-facing head band speaker 825 may be embedded in head band 820. Speaker 825 may extend along a desired length of the head band 820 between the earcup 815 and a second earcup on the other side of the user 800.

Headset 810 may also include forward-facing lighting 830 via light-emitting diodes or other light sources is also included, wherein the lighting can have different colors selected to alert others to the user's status, such as being on a call, playing a game, or muted. Lights 830 are shown on a front-facing side of the head band 820. Additional lights 835 may be supported by the outsides of the earcups so that they are visible to people to the side of the user 800. In one example, lights of the color blue or green may be used to indicate that the user is engaged in listening to audio. Red or yellow may indicate that the headset is muted. The color choices may be varied in different examples to communicate different states of audio engagement or user-selected meanings.

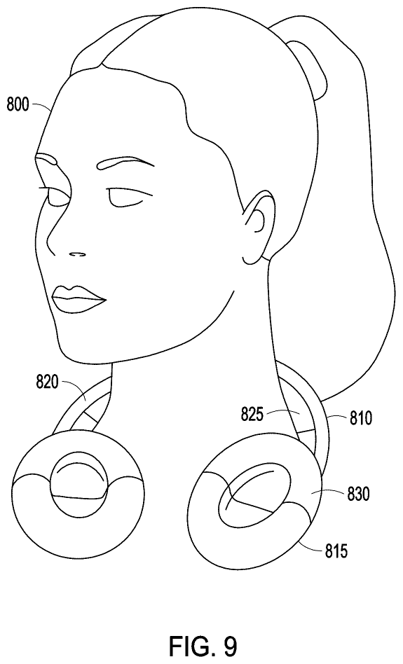

FIG. 9 is a perspective view of the user 800 wearing the headset 810 around the user's neck and resting on their shoulders. The front facing head band speaker 825 is projecting sound toward the ears and acts as a neck speaker option. The sound is perceivable by the user 800 with the headset 810 off the ears and resting around the neck.

In one example, a physical switch 830 may be disposed on the earcup 814 or head band 820 and coupled to switch audio signals between earcup speakers and head band speakers 825. Switch 830 may alternatively comprise a sensor configured to distinguish between headset 810 being worn on the head of the user or around the neck of the user. Such sensors may be a capacitive sensor having a capacitance that varies with distance to a selected body part, or even a software-based switch operated via a user interface in audio source 725, which may be a computer. The switch 830 in one example is a physical switch on a side of the head band 820 that is depressed when the headset 810 is worn with the head band contacting the top of the user's head.

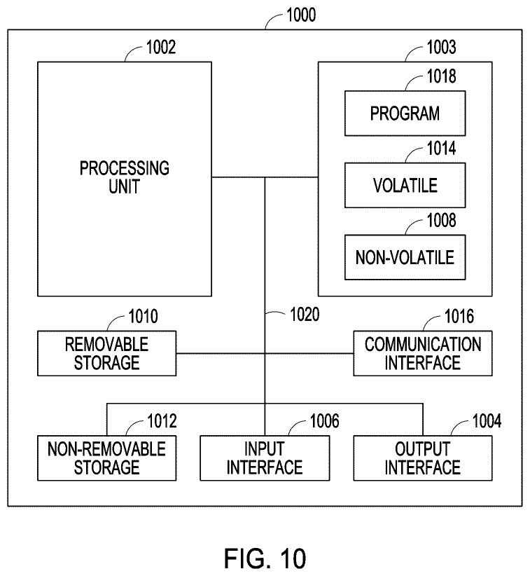

FIG. 10 is a block schematic diagram of a computer system 1000 to provide processing capabilities for headsets and audio sources and for performing methods and algorithms according to example embodiments. All components need not be used in various embodiments.

One example computing device in the form of a computer 1000 may include a processing unit 1002, memory 1003, removable storage 1010, and non-removable storage 1012. Although the example computing device is illustrated and described as computer 1000, the computing device may be in different forms in different embodiments. For example, the computing device may instead be a smartphone, a tablet, smartwatch, smart storage device (SSD), or other computing device including the same or similar elements as illustrated and described with regard to FIG. 10. Devices, such as smartphones, tablets, and smartwatches, are generally collectively referred to as mobile devices or user equipment.

Although the various data storage elements are illustrated as part of the computer 1000, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 1003 may include volatile memory 1014 and non-volatile memory 1008. Computer 1000 may include - or have access to a computing environment that includes - a variety of computer-readable media, such as volatile memory 1014 and non-volatile memory 1008, removable storage 1010 and non-removable storage 1012. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 1000 may include or have access to a computing environment that includes input interface 1006, output interface 1004, and a communication interface 1016. Output interface 1004 may include a display device, such as a touchscreen, that also may serve as an input device. The input interface 1006 may include one or more of a touchscreen, touchpad, mouse, keyboard, camera, one or more device-specific buttons, one or more sensors integrated within or coupled via wired or wireless data connections to the computer 1000, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 1000 are connected with a system bus 1020.

Computer-readable instructions stored on a computer-readable medium are executable by the processing unit 1002 of the computer 1000, such as a program 1018. The program 1018 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 1018 may be used to cause processing unit 1002 to perform one or more methods or algorithms described herein.

### EXAMPLES

1. An adaptable headset includes a head band adapted to reside on a user head, the head band including a first head band end and a second head band end. A pair of earcups is supported by one of the first head band end or second head band end to reside proximate an ear of the user. Each earcup includes a first earcup portion coupled to the first head band end or the second head band end, a first speaker supported within the first earcup portion, and a second earcup portion detachably couplable to the first earcup portion.
2. The adaptable headset of example 1 wherein the first earcup portion and the second earcup portion include means for aligning the first earcup portion and the second earcup portion in an attached state.
3. The adaptable headset of example 2 wherein the means for aligning comprise opposed projections and openings that also operate to releasably retain the first earcup portion and the second earcup portion in the attached state.
4. The adaptable headset of any of examples 1-3 and further comprising means for releasably retaining the first earcup portion and the second earcup portion.
5. The adaptable headset of example 4 wherein the means for releasably retaining comprises an opposing pair of a magnet and magnetic material coupled to the first earcup portion and the second earcup portion.
6. The adaptable headset of any of examples 1-5 wherein the first earcup portion is rotatable coupled to the to the first head band end or the second head band end.
7. The adaptable headset of example 6 wherein the first earcup portion is configured to rotate to reside over a back of an ear of the user.
8. The adaptable headset of any of examples 1-7 wherein the head band includes a second speaker supported by a head band speaker portion of the head band positioned between the first head band end and the second head band end.
9. The adaptable headset of example 8 wherein the second speaker is supported to project sound toward the ears of the user while the headset is resting on shoulders of the user.
10. The adaptable headset of example 9 wherein the head band includes at least one light configured to emit different color light corresponding to sound being muted or playing via the first speaker or the second speaker.
11. The adaptable headset of any of examples 1-10 wherein the first earcup portion includes at least one light configured to emit different color light selected to alert others to the user's status, such as being on a call, playing a game, or muted.
12. The adaptable headset of any of examples 1-11 wherein the first earcup portion includes at least one light configured to emit different color light selected to alert others to the user's status, such as being on a call, playing a game, or muted.
13. The adaptable headset of any of examples 1-12 wherein the first earcup portion first speaker is configured to receive and play a first channel of audio and wherein the second earcup portion first speaker is configured to receive and play a second channel of audio.
14. The adaptable headset of example 13 wherein the first channel and the second channel of audio are provided to the adaptable headset from a wired or wirelessly connected audio source.
15. An adaptable headset includes a head band adapted to reside on a user head, the head band including a curved head band body supported between a first head band end and a second head band end, a first upper earcup portion supported by the first head band end and configured to fit about a top or back of a first ear of the user, a first lower earcup portion detachably couplable to the first upper earcup portion, a first speaker supported by the first upper earcup portion and positioned to provide sound to the first ear of the user a second upper earcup supported by the second head band end and configured to fit about a top or back of a second ear of the user. a second lower earcup portion detachably couplable to the second upper earcup portion, a second speaker supported by the first upper earcup portion and positioned to provide sound to the first ear of the user.
16. The adaptable headset of example 15 wherein the first and second upper earcup portions and lower earcup portions include means for aligning and releasably retaining the upper earcup portions with the lower earcup portions in an attached state.
17. The adaptable headset of any of examples 15-16 wherein the first and second upper earcup portions are rotatable to move from a top of the user ear to a back of the user ear.
18. The adaptable headset of any of examples 15-16 wherein the head band includes a second speaker supported by a head band speaker portion of the head band positioned between the first head band end and the second head band end to project sound toward the ears of the user while the headset is resting on shoulders of the user.
19. The adaptable headset of example 18 wherein at least one of the head band or the upper earcup portions include at least one light configured to emit different color light selected to alert others to the user's status, such as being on a call, playing a game, or muted.
20. An adaptable headset includes adjustable earcups configured to fit earrings, eyeglass frames, and headgear, wherein the earcups are detachable or swivelable to accommodate these accessories, moveable or detachable earcup portions to allow the user to remove portions for a more comfortable fit, a system for providing separate audio activities to each earcup, enabling the user to listen to different audio sources in each ear, a neck speaker option that allows sound to be perceivable by the user with the headset off the ears and resting around the neck, and forward-facing lighting via light-emitting diodes or other light sources, wherein the lighting can have different colors selected to alert others to the user's status, such as being on a call, playing a game, or muted.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. An adaptable headset comprising:
a head band adapted to reside on a user head, the head band including a first head band end and a second head band end; and
a pair of earcups, each earcup supported by one of the first head band end or second head band end to reside proximate an ear of the user and each earcup comprising:
a first earcup portion coupled to the first head band end or the second head band end;
a first speaker supported within the first earcup portion; and
a second earcup portion detachably couplable to the first earcup portion.

2. The adaptable headset of claim 1 wherein the first earcup portion and the second earcup portion include means for aligning the first earcup portion and the second earcup portion in an attached state.

3. The adaptable headset of claim 2 wherein the means for aligning comprise opposed projections and openings that also operate to releasably retain the first earcup portion and the second earcup portion in the attached state.

4. The adaptable headset of claim 1 and further comprising means for releasably retaining the first earcup portion and the second earcup portion.

5. The adaptable headset of claim 4 wherein the means for releasably retaining comprises an opposing pair of a magnet and magnetic material coupled to the first earcup portion and the second earcup portion.

6. The adaptable headset of claim 1 wherein the first earcup portion is rotatable coupled to the to the first head band end or the second head band end.

7. The adaptable headset of claim 6 wherein the first earcup portion is configured to rotate to reside over a back of an ear of the user.

8. The adaptable headset of claim 1 wherein the head band includes a second speaker supported by a head band speaker portion of the head band positioned between the first head band end and the second head band end.

9. The adaptable headset of claim 8 wherein the second speaker is supported to project sound toward the ears of the user while the headset is resting on shoulders of the user.

10. The adaptable headset of claim 9 wherein the head band includes at least one light configured to emit different color light corresponding to sound being muted or playing via the first speaker or the second speaker.

11. The adaptable headset of claim 1 wherein the first earcup portion includes at least one light configured to emit different color light selected to alert others to a user's status, such as being on a call, playing a game, or muted.

12. The adaptable headset of claim 1 wherein the first earcup portion includes at least one light configured to emit different color light selected to alert others to a user's status, such as being on a call, playing a game, or muted.

13. The adaptable headset of claim 1 wherein the first earcup portion first speaker is configured to receive and play a first channel of audio and wherein the second earcup portion first speaker is configured to receive and play a second channel of audio.

14. The adaptable headset of claim 13 wherein the first channel and the second channel of audio are provided to the adaptable headset from a wired or wirelessly connected audio source.

15. An adaptable headset comprising:
a head band adapted to reside on a user head, the head band including a curved head band body supported between a first head band end and a second head band end;
a first upper earcup portion supported by the first head band end and configured to fit about a top or back of a first ear of the user;
a first lower earcup portion detachably couplable to the first upper earcup portion;
a first speaker supported by the first upper earcup portion and positioned to provide sound to the first ear of the user;
a second upper earcup supported by the second head band end and configured to fit about a top or back of a second ear of the user;
a second lower earcup portion detachably couplable to the second upper earcup portion;
a second speaker supported by the first upper earcup portion and positioned to provide sound to the first ear of the user.

16. The adaptable headset of claim 15 wherein the first and second upper earcup portions and lower earcup portions include means for aligning and releasably retaining the upper earcup portions with the lower earcup portions in an attached state.

17. The adaptable headset of claim 15 wherein the first and second upper earcup portions are rotatable to move from a top of the user ear to a back of the user ear.

18. The adaptable headset of claim 15 wherein the head band includes a second speaker supported by a head band speaker portion of the head band positioned between the first head band end and the second head band end to project sound toward the ears of the user while the headset is resting on shoulders of the user.

19. The adaptable headset of claim 18 wherein at least one of the head band or the upper earcup portions include at least one light configured to emit different color light selected to alert others to a user's status, such as being on a call, playing a game, or muted.

20. An adaptable headset comprising:
adjustable earcups configured to fit earrings, eyeglass frames, and headgear, wherein the earcups are detachable or swivelable to accommodate these accessories;
moveable or detachable earcup portions to allow a user to remove portions for a more comfortable fit;
a system for providing separate audio activities to each earcup, enabling the user to listen to different audio sources in each ear;
a neck speaker option that allows sound to be perceivable by the user with the headset off the ears and resting around the neck; and
forward-facing lighting via light-emitting diodes or other light sources, wherein the lighting can have different colors selected to alert others to the user's status, such as being on a call, playing a game, or muted.
